(19) United States
(12) Patent Application Publication
(10) Pub. No.: US 2011/0205000 A1
(43) Pub. Date: Aug. 25, 2011

(54) DIVIDABLE WAVEGUIDE

(75) Inventors: Takayuki Oyama, Minato-ku (JP); Naotsugu Watanabe, Minato-ku (JP)

(73) Assignee: NEC CORPORATION, MINATO-KU, TOKYO (JP)

(21) Appl. No.: 12/302,213

(22) PCT Filed: Mar. 5, 2008
(86) PCT No.: PCT/JP2008/053915

§ 371 Date: Nov. 24, 2008

(30) Foreign Application Priority Data
Mar. 5, 2007 (JP) 2007-054560

(51) Int. Cl. H01P 3/12

(52) U.S. Cl. 333/239

(57) ABSTRACT

A division type waveguide circuit is provided, in which fixing a metal cover to a waveguide body with screws can prevent radiowave leak suitably without any application of the conductive adhesive, solder and braze as a material for the radiowave leak prevention. A radiowave leak preventing plate 8 is provided at the end of an opening area 3 of a waveguide body 2 in a radiowave traveling direction and overlaps with the end of a metal cover 4.

### TECHNICAL FIELD

(An explanation of the related application) The present application is based on the priority of Japanese patent application No. 2007-054560 (filed on Mar. 5, 2007). The entire disclosure of the prior application is regarded as incorporated therein by reference thereto.

The present invention relates to a dividable waveguide circuit having functions of transmission of a radio wave as well as a distributor and coupler, i.e., a functional waveguide.

### BACKGROUND ART

FIG. 5 shows an example of a waveguide circuit according to a background art. In the waveguide circuit according to the background art, an opening of a waveguide body 101 which is a metal case is covered with a metal cover 102. A radiowave leak preventing material 103, such as conductive adhesive, solder or braze, is provided on the outside in order to prevent the radiowave from leaking between an edge of the metal cover and an edge of the opening in a radiowave traveling direction (in the longitudinal direction of the waveguide body 101).

A waveguide 104 in which the opening of the waveguide body 101 is covered with the metal cover 102 is connected with a connecting waveguide 105 by connecting flanges 104a, 105a with each other.

Patent document 1 (JP-S53-10239U) and Patent document 2 (JP3750856B) disclose a combination of a waveguide body and a metal cover.
Patent document 1: JP-S53-10239U
Patent document 2: JP3750856B

### DISCLOSURE OF THE INVENTION

### Problems to be Solved by the Invention

Disclosures of Patent documents 1-2 are regarded as incorporated herein by reference thereto. An analysis on the related art will be provided below based on the present invention.

Application of the radiowave leak preventing material 103 as illustrated in FIG. 5 takes a lot of working time.

Patent documents 1-2 provide no consideration on prevention of the radiowave leak in the radiowave traveling direction.

It is an object of the present invention to provide a dividable waveguide circuit which can achieve the prevention of the radiowave leak suitably by merely securing a metal cover on a waveguide body without any application of the conductive adhesive, solder or braze as a material for the radiowave leak prevention.

### Means to Solve the Problems

A dividable waveguide circuit of the present invention comprises a waveguide body having an opening and a metal cover covering the opening, a radio-wave leak preventing plate being provided at an end of the opening in a radio-wave traveling direction and overlapping with an end of the metal cover.

### Meritorious Effects of the Invention

According to the present invention, the radiowave leak preventing plate disposed on the waveguide body can prevent the radiowave leak by merely securing the metal cover on the waveguide body with, for example, a screw without the application of the conductive adhesive, solder or braze as a material for the radiowave leak prevention.

### BRIEF DESCRIPTION OF THE DRAWINGS

FIG. 1 is a perspective view in common with exemplary embodiments 1-3 of the present invention.

FIG. 2 is a cross sectional view of example 1.

FIG. 3 is a cross sectional view of example 2.

FIG. 4 is a cross sectional view of example 3.

FIG. 5 is a cross sectional view of an example according to a background (related) art.

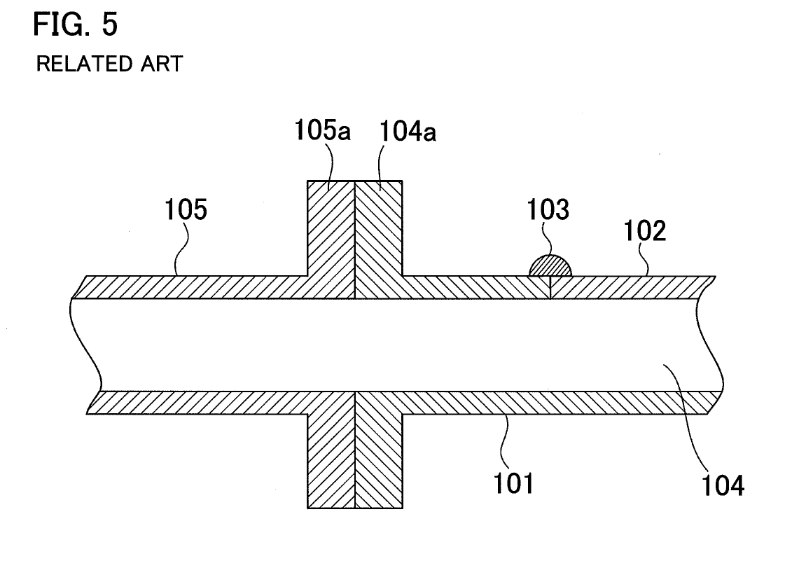

### EXPLANATIONS OF SYMBOLS

1 Division type waveguide
2 Waveguide body
3 Opening (area)
4 Metal cover
5 Flange
6 Connecting waveguide
7 Flange
8 Radiowave leak preventing plate
9 Screw
10 Waveguide portion
11 Matching waveguide portion

### PREFERRED MODES FOR CARRYING OUT THE INVENTION

According to a first aspect, in a division type waveguide circuit in which an opening of a waveguide body is covered with a metal cover, a radiowave leak preventing plate is provided at an end of the opening area (or surface) of the wave guide body in a radiowave traveling direction and overlaps with an end of the metal cover.

In a preferred exemplary embodiment of the first aspect, the radio-wave leak preventing plate is disposed integral with the waveguide body at the opening (area (or surface)). According to this exemplary embodiment, the radiowave leak can be prevented suitably since the radiowave leak preventing plate is formed in unison with the waveguide body.

In a preferred exemplary embodiment of the first aspect, the opening of the waveguide body extends elongated in the radiowave traveling direction. The metal cover is secured onto both lateral sides of the opening by screwing. According to this exemplary embodiment, the division type (may be termed as “dividable”) waveguide circuit can be constructed in a short time by merely securing the metal cover onto the lateral sides of the opening with screws.

In a preferred exemplary embodiment of the first aspect, the dividable waveguide circuit comprises the waveguide body as described above and a connecting waveguide connecting with the waveguide body by abutting their flanges with each other. In the dividable waveguide circuit, a part of the waveguide body from the radio-wave leak preventing plate to the flange serves (acts) as a waveguide matching portion which matches impedances between a waveguide portion, which is a part of the waveguide body forming the opening area (or surface), and the connecting waveguide. According to this exemplary embodiment, the impedance matching with the connecting waveguide can be achieved by the part of the waveguide body extending from the radiowave leak preventing plate to the flange.

In a preferred exemplary embodiment of the first aspect and, especially, a first concrete example of the waveguide circuit having the above connection, when the opening area of the waveguide body faces upward, an upper inner surface of the matching waveguide portion is lower than a lower surface of the metal cover and an upper inner surface of the connecting waveguide, so that the inner surfaces of the waveguide portion, matching waveguide portion and connecting waveguide are at the same height as (flush with) one another. According to this exemplary embodiment, there is no step difference since the bottom inner surfaces of the waveguide portion, matching waveguide portion and connecting waveguide are flush with one another. Therefore, the efficiency in the manufacturing becomes is improved because burring work for removing burs caused by the step difference is unnecessary.

In a preferred exemplary embodiment of the first aspect and, especially, a second concrete example, when the opening area of the waveguide body faces upward, the upper inner surface of the matching waveguide portion is lower than the lower surface of the metal cover and the upper inner surface of the connecting waveguide, the bottom inner surface of the matching waveguide portion being lower than the bottom inner surface of the waveguide portion, the bottom inner surface of the connecting waveguide is further lower than the inner bottom surface of the matching waveguide portion. According to this exemplary embodiment, if the impedances of the waveguide portion, matching waveguide portion and connecting waveguide portion are same as one another, the length of the matching waveguide portion may be selected as required, which results in an improved adaptability in the structure (designing) of the waveguide portion and connecting waveguide.

In a preferred exemplary embodiment of the first aspect and, especially, a third concrete example, when the opening area of the waveguide body faces upward, the upper inner surface of the matching waveguide portion is lower than the lower surface of the metal cover and the upper inner surface of the connecting waveguide, the bottom inner surface of the matching waveguide portion being lower than the bottom inner surface of the waveguide portion and the bottom inner surface of the connecting waveguide. According to this exemplary embodiment, the property of VSWR (Voltage Standing Wave Ratio) which is a ratio of the maximum value of a voltage standing wave to the minimum value becomes better than the cases with claims 5-6 under the condition that the impedances of the waveguide portion and connecting waveguide are the same.

Next, examples of the present invention will be explained in detail referring to drawings.

### EXAMPLES

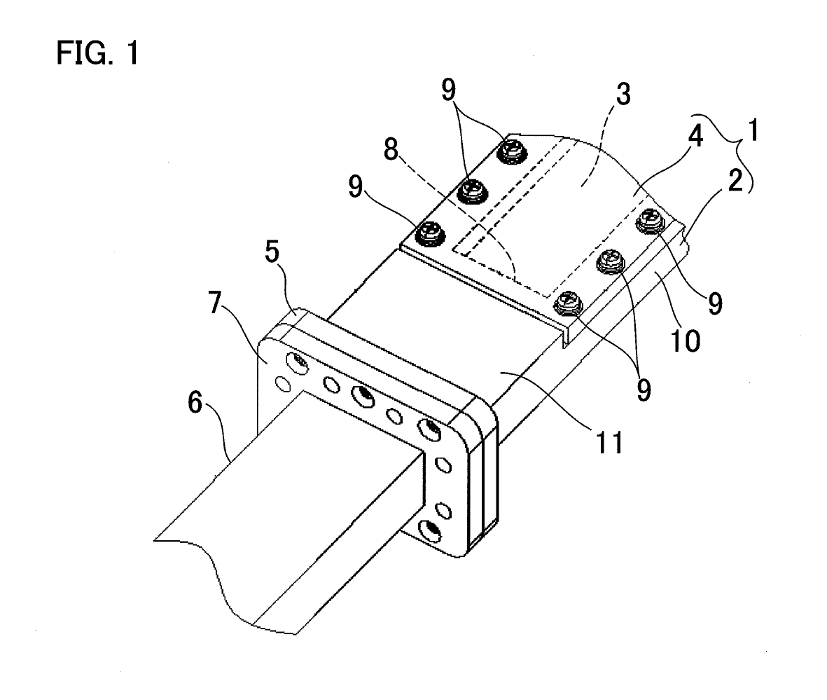

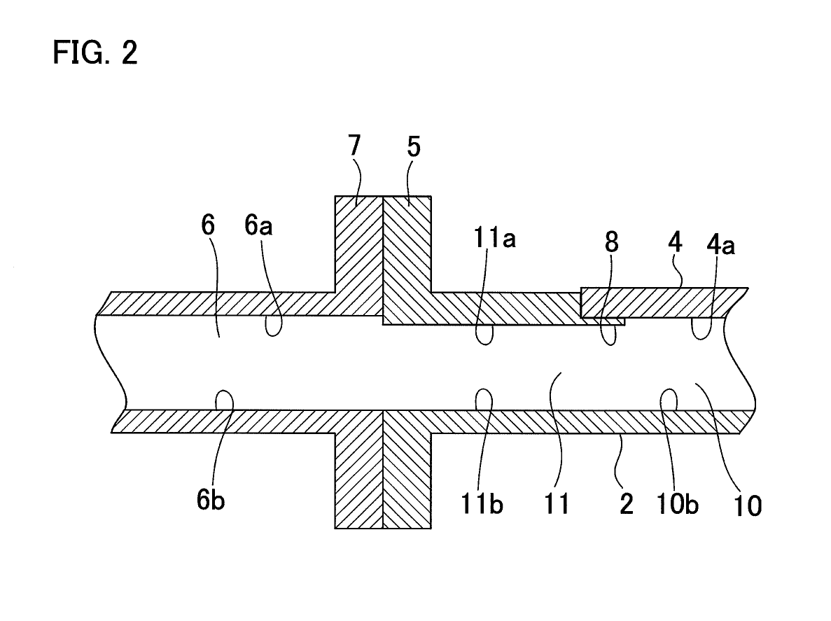

FIG. 1 shows a perspective view of an external appearance in common with examples 1-3 of the present invention. FIG. 2 shows a cross sectional view in example 1.

In FIG. 1, a division type (dividable) waveguide 1 comprises a waveguide body 2 which is a metal case in the shape of a rectangular tube, and a metal plate cover 4 covering an opening (area (or surface)) 3 on the top surface of the waveguide body. The waveguide body 2 has a flange 5 as a part at an end. The flange 5 is connected with a flange 7 of another waveguide, which is a connecting waveguide 6, to connect the dividable waveguide 1 with the connecting waveguide 6.

The opening area 3 of the waveguide body 2 extends up to a position near (upstream) the flange 5 in the radiowave traveling direction (in the longitudinal direction of the waveguide body 2). A radio-wave leak preventing plate 8 is formed integral with the waveguide body 2 at the end of the opening 3.

The end of the metal cover 4 is disposed on overlapping with the radiowave leak preventing plate 8. The metal cover 4 is secured on to the waveguide body 2 with screws 9 at both lateral sides of the opening 3 entirely, so as to cover up to the necessary peripheral region around the opening area 3, extending beyond the opening edge of the opening area 3.

In the dividable waveguide 1 assembled by the waveguide body 2 and the metal cover 4 in the above manner, the most portion, which is covered with the metal cover 4, is regarded as an inherent waveguide portion 10, whereby a portion ranging from the radiowave leak preventing plate 8 to the flange 5 constitutes a matching waveguide portion 11 which matches impedances with the connecting waveguide 6.

Relating to the opening area 3 of the dividable waveguide 1 as formulated above, a structure in which the end of the metal cover 4 overlaps the radiowave leak preventing plate 8 can prevent the radiowave from leaking occurring in the radiowave traveling direction. If the radiowave leaks outward, an unnecessary radiant wave and increase in transmission loss will occur.

Also, by designing the distance between the waveguide portion 10 and the connecting waveguide 6 suitably, the impedance matching can be achieved between the waveguide portion 10 and the connecting waveguide 6. If the impedance matching goes wrong, the increase in the transmission loss and reflection of an RF signal back to the input side will occur. Thus, the level of the transmitted RF signal will be reduced.

In the cross sectional view as illustrated in FIG. 2, a top wall of the waveguide body 2 at the end of the opening 3 is made thinner partially so as to form a step difference (an L-shape), thus providing the radiowave leak preventing plate 8. In example 1, an upper inner top surface 11a of the matching waveguide portion 11 is lower than a lower surface 4a of the metal cover 4 and an upper inner surface 6a of the connecting waveguide 6. The bottom surfaces 10b, 11b, 6b of the insides of the waveguide portion 10, matching waveguide portion 11 and connecting waveguide 6 are at the same level so as to be flush with another one. From the point of view of the height of each central line, as illustrated by broken lines, the central line of the waveguide portion 10 is at the same height as the central line of the connecting waveguide 6, while the central line of the matching waveguide portion 11 is lower than these lines.

According to the formulation of example 1, if an impedance of the connecting waveguide 6 is the same as an impedance of the waveguide portion 10, impedance matching can become satisfactory when a length of the matching waveguide portion 11 is about half of a wavelength in the pipe. If an impedance of the connecting waveguide is different from an impedance of the waveguide portion 10, impedance matching can become satisfactory when the length of the matching waveguide portion 11 is about quarter of the wavelength in the pipe.

Since the lower (bottom) inner surfaces 10b, 11b, 6b of the waveguide portion 10, the matching waveguide portion 11 and the connecting waveguide 6 are at the same height so as to flush one surface, burring work for removing caused by (forming) the step difference becomes unnecessary.

### Example 2

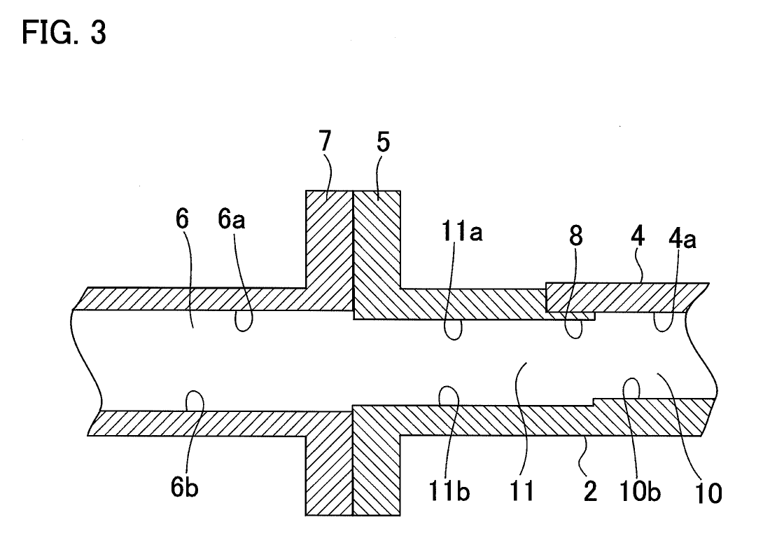

FIG. 3 shows the cross sectional view of example 2. The following points are different from example 1.

The upper inner surface 11a of the matching waveguide portion 11 is lower than the lower surface 4a of the metal cover 4 and the upper inner surface 6a of the connecting waveguide 6. The bottom inner surface 11b of the matching waveguide portion 11 is lower than the bottom inner surface 10b of the waveguide portion 10. The bottom inner surface 6b of the connecting waveguide 6 is further lower than the bottom inner surface 11b of the matching waveguide portion 11. From the point of view of the heights of the central lines of the waveguide portion 10, matching waveguide portion 11 and connecting waveguide 6, the central line of the connecting waveguide 6 is at the same height as the central line of the matching waveguide portion 11, and the central line of the waveguide portion 10 is higher than these central lines.

According to example 2, if the impedances among the waveguide portion 10, matching waveguide portion 11 and connecting waveguide 6 become the same, since the length of the matching waveguide portion 11 can be designed as desired the waveguide portion 10 and connecting waveguide 11 can be adapted easily, as far as the structure is concerned.

### Example 3

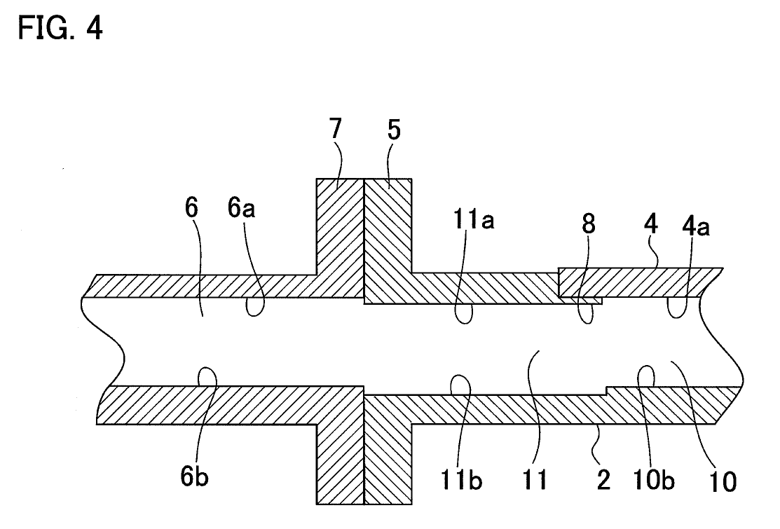

FIG. 4 shows the cross sectional view of example 3. The following points are different from example 1.

The upper inner surface 11a of the matching waveguide portion 11 is lower than the lower surface 4a of the metal cover 4 and the upper inner surface 6a of the connecting waveguide 6. The bottom inner surface 11b of the matching waveguide portion 11 is lower than of the bottom inner surface 10b of the waveguide portion 10 and bottom surface 6b of the inside of the connecting waveguide 6. From the point of view of the heights of the central lines among the waveguide portion 10, matching waveguide portion 11 and connecting waveguide 6, the central line of the waveguide portion 10 is at the same height as the central line of the connecting waveguide 6, whereas the central line of the matching waveguide portion 11 is lower than these central lines and than the case in example 1.

According to example 3, electric performance is better than examples 1-2. If the impedances of waveguide portion 10 and connecting waveguide 6 are the same, the VSWR properties are 1.03 or less in example 1, 1.02 or less in example 2, and 1.01 or less in example 3. The value of the example 3 is best.

The examples and examples are modifiable and adaptable based on the technical idea within the disclosure (including claims) of the present invention. The disclosed subject matters may be combined or selected within the claims of the present invention.

1. A division type waveguide circuit comprising:
a waveguide body having an opening area (or surface),
a metal cover covering said opening area (or surface), and
a radio-wave leak preventing plate;
wherein said radiowave leak preventing plate is provided at an end of said opening area (or surface) in a radio-wave traveling direction and overlaps with an end of said metal cover.

2. The division type waveguide circuit according to claim 1, wherein
said radiowave leak preventing plate is formed as a part of said waveguide body at said opening area (or surface).

3. The division type waveguide circuit according to claim 1, wherein
said opening area (or surface) of said waveguide body extends in a radiowave traveling direction, and
the metal cover is secured with at least one screw at both lateral sides of said opening area (or surface).

4. The division type waveguide circuit according to claim 1, further comprising:
a connecting waveguide, having a flange, to connect with said waveguide body; wherein said waveguide body comprises a flange,
the flange of said waveguide body is connected with the flange of said connecting waveguide to connect said waveguide body with said connecting waveguide; and
a part of said waveguide body extending from said radiowave leak preventing plate to the flange of said waveguide body is formed as a matching waveguide portion which matches impedances between a waveguide portion which is a part of forming said opening area (or surface) of said waveguide body and said connecting waveguide.

5. The division type waveguide circuit according to claim 4, wherein
assuming said opening area (or surface) of said waveguide body faces upward, an upper inner surface of said matching waveguide portion is lower than a lower surface of said metal cover and an upper inner surface of said connecting waveguide, and
bottom inner surfaces of said waveguide portion, said matching waveguide portion and said connecting waveguide are at the same height as one another.

6. The division type waveguide circuit according to claim 4, wherein
assuming said opening area (or surface) of said waveguide body faces upward, an upper inner surface of said matching waveguide portion is lower than a lower surface of said metal cover and an upper inner surface of said connecting waveguide,
a bottom inner surface of said matching waveguide portion is lower than a bottom inner surface of said waveguide portion, and
a bottom inner surface of said connecting waveguide is further lower than the bottom inner surface of said matching waveguide portion.

7. The division type waveguide circuit according to claim 4, wherein
assuming said opening area (or surface) of said waveguide body faces upward, an upper inner surface of said matching waveguide portion is lower than a lower inner surface of said metal cover and an upper inner surface of said connecting waveguide, and
a bottom inner surface of said matching waveguide portion is lower than a bottom inner surface of said waveguide portion and a bottom inner surface of said connecting waveguide.

8. The division type waveguide circuit according to claim 2, wherein
said waveguide body comprises a flange for connecting with a connecting waveguide, and
a part of said waveguide body extending from said radiowave leak preventing plate to the flange of said waveguide body is formed as a matching waveguide portion which matches impedances between a waveguide portion which is a part of forming said opening area (or surface) of said waveguide body and said connecting waveguide.

9. The division type waveguide circuit according to claim 8, wherein
assuming said opening area (or surface) of said waveguide body faces upward, an upper inner surface of said matching waveguide portion is lower than a lower surface of said metal cover and an upper inner surface of said connecting waveguide, and
bottom inner surfaces of said waveguide portion, said matching waveguide portion and said connecting waveguide are at the same height as one another.

10. The division type waveguide circuit according to claim 8, wherein
assuming said opening area (or surface) of said waveguide body faces upward, an upper inner surface of said matching waveguide portion is lower than a lower surface of said metal cover and an upper inner surface of said connecting waveguide,
a bottom inner surface of said matching waveguide portion is lower than a bottom inner surface of said waveguide portion, and
a bottom inner surface of said connecting waveguide is further lower than the bottom inner surface of said matching waveguide portion.

11. The division type waveguide circuit according to claim 8, wherein
assuming said opening area (or surface) of said waveguide body faces upward, an upper inner surface of said matching waveguide portion is lower than a lower inner surface of said metal cover and an upper inner surface of said connecting waveguide, and
a bottom inner surface of said matching waveguide portion is lower than a bottom inner surface of said waveguide portion and a bottom inner surface of said connecting waveguide.
